(19) United States
(12) Patent Application Publication
(10) Pub. No.: US 2026/0040413 A1
(43) Pub. Date: Feb. 5, 2026

(54) INDUCTION COOKER INTEGRATED STOVE

(71) Applicant: GUANGDONG ARCAIR APPLIANCE CO., LTD., FOSHAN (CN)

(72) Inventors: Zuotian KANG, FOSHAN (CN); Haijiang TANG, FOSHAN (CN); Quankun CAI, FOSHAN (CN)

(73) Assignee: GUANGDONG ARCAIR APPLIANCE CO., LTD., FOSHAN (CN)

(21) Appl. No.: 19/276,171

(22) Filed: Jul. 22, 2025

(30) Foreign Application Priority Data
Jul. 30, 2024 (CN) 202421815052.X

(51) Int. Cl. H05B 6/12; F24C 7/06; F24C 15/20; H05B 6/06

(52) U.S. Cl. CPC H05B 6/1209; F24C 7/062; F24C 15/20; H05B 6/062

(57) ABSTRACT

The present disclosure discloses an induction cooker integrated stove, and belongs to the field of induction cooker technologies. The induction cooker integrated stove includes an induction cooker bottom housing, a machine housing below the induction cooker bottom housing, an induction cooker hot plate module and an induction cooker electric control module. The induction cooker hot plate module is mounted inside the induction cooker bottom housing and includes at least one induction cooker hot plate. The induction cooker electric control module is separated from the induction cooker hot plate module and separately mounted on the machine housing. The induction cooker electric control module is connected with the induction cooker hot plate to control the induction cooker hot plate. In the induction cooker integrated stove of the present disclosure, the induction cooker bottom housing has a smaller thickness so as to meet the mounting requirement of the working bench with small countertop thickness, thereby improving the general applicability of the induction cooker integrated stove.

### TECHNICAL FIELD

The present disclosure belongs to the field of induction cooker technologies and in particular to an induction cooker integrated stove.

### BACKGROUND

With reference to FIGS. 3 and 4, there is a current induction cooker integrated stove, which includes an induction cooker bottom housing 110, a machine housing 120 below the induction cooker bottom housing 110, an induction cooker hot plate 210 and an induction cooker electric control device 500. The induction cooker hot plate 210 and the induction cooker electric control device 500 are arranged up and down and fixedly connected into one piece (referred to as hot plate assembly). The hot plate assembly is entirely mounted inside the induction cooker bottom housing 110, increasing the thickness of the induction cooker bottom housing 110.

When the induction cooker integrated stove is actually mounted, the machine housing 120 runs through the cooking bench 600 and is placed below the cooking bench 600, while the induction cooker bottom housing 110 is embedded into a pre-designed mounting groove 610 of the cooking bench 600 (a panel 130 on the induction cooker bottom housing 110 is flush with the surface of the cooking bench 600, better meeting the requirements of the consumers). But, since the countertop thickness of some cooking benches is small, the mounting groove with the depth consistent with the thickness of the induction cooker bottom housing cannot be cut, leading to non-applicability of the induction cooker integrated stove to these cooking benches and lowering the general applicability of the induction cooker integrated stove.

Therefore, it is necessary to make improvement and development on the prior arts.

### SUMMARY

The object of the present disclosure is to provide an induction cooker integrated stove with an induction cooker bottom housing having a smaller thickness to satisfy the mounting requirement of the cooking benches with smaller countertop thickness, thereby improving general applicability of the induction cooker integrated stove.

According to a first aspect, the present disclosure provides an induction cooker integrated stove, which includes an induction cooker bottom housing, a machine housing below the induction cooker bottom housing, and an induction cooker hot plate module; where the induction cooker hot plate module is mounted inside the induction cooker bottom housing and includes at least one induction cooker hot plate; and the induction cooker integrated stove further includes:

an induction cooker electric control module, where the induction cooker electric control module is separated from the induction cooker hot plate module and separately mounted on the machine housing; the induction cooker electric control module is connected with the induction cooker hot plate to control the induction cooker hot plate.

In the induction cooker integrated stove provided by the present disclosure, modular induction cooker hot plate module and induction cooker electric control module are designed. The induction cooker electric control module is no longer fixedly connected with the induction cooker hot plate module so that the induction cooker electric control module can be removed out of the induction cooker bottom housing, achieving the effect of reducing the thickness of the induction cooker bottom housing and improving the general applicability of the induction cooker integrated stove.

Furthermore, the induction cooker electric control module is connected with the induction cooker hot plate by a detachable wire and detachably connected with the machine housing.

After the wire is pulled out, the induction cooker electric control module can be taken out separately, helping the user to repair or change the induction cooker electric control module.

Furthermore, the induction cooker electric control module is mounted inside the machine housing.

Furthermore, the induction cooker electric control module is mounted on an outer side of the machine housing.

The induction cooker electric control module is disposed outside the machine housing, which, on the one hand, helps heat dissipation of the induction cooker electric control module, and on the other hand, better helps the user to repair the induction cooker electric control module.

Furthermore, disposed on the induction cooker bottom housing is a panel provided with an air inlet penetrating through the panel in an up-down direction;

The induction cooker integrated stove further includes an air guide groove and a fan; one end of the air guide groove is in communication with the air inlet and the other end is connected with the fan; the fan is used to extract oil fume through the air guide groove.

The induction cooker integrated stove is integrated with an oil fume extracting function, which achieves the oil fume reduction effect.

Furthermore, the air guide groove includes a first air channel and a second air channel; the first air channel is in communication with the second air channel to form an air channel structure with an L-shaped section; the first air channel extends in the up-down direction and communicates with the air inlet, and the second air channel extends in a left-right direction and connects with the fan.

Furthermore, an end of the first air channel close to the air inlet is connected with a filtering device.

Furthermore, the filtering device includes an air inlet cover, a water receiving box and a strainer; the water receiving box is inserted into the first air channel with an opening disposed on top; the air inlet cover is mounted on the water receiving box and covered on the opening; the strainer is mounted on a peripheral side of the water receiving box.

Furthermore, a bottom surface of the second air channel is an inclined surface tilted from top down toward the bottom of the first air channel in the left-right direction.

Furthermore, a water outlet disposed at the bottom of the first air channel, and a water receiving tray is mounted below the water outlet and communicated with the water outlet.

It can be known that in the induction cooker integrated stove of the present disclosure, modular designing is carried out to enable the traditional induction cooker hot plate and induction cooker electric control device to become the induction cooker hot plate module and the induction cooker electric control module independent of each other, and the induction cooker electric control module can be removed from the induction cooker bottom housing so as to further reduce the thickness of the induction cooker bottom housing. Therefore, the induction cooker integrated stove can be mounted on the cooking bench with smaller countertop thickness, effectively improving its entire general applicability.

Other features and advantages of the present disclosure can be set forth in subsequent specification, and partially become apparent from the specification or be known by practice of the embodiments of the present disclosure. The objects and other advantages of the present disclosure can be implemented and obtained by the structures specifically indicated in the written specification and drawings.

### BRIEF DESCRIPTION OF THE DRAWINGS

FIG. 1 is an exploded view illustrating a first induction cooker integrated stove according to an embodiment of the present disclosure.

FIG. 2 is an exploded view illustrating a second induction cooker integrated stove according to an embodiment of the present disclosure.

FIG. 3 is a structural schematic diagram illustrating a current induction cooker integrated stove and a cooking bench.

FIG. 4 is an exploded view illustrating a current induction cooker integrated stove and a cooking bench.

FIG. 5 is a sectional view illustrating a local structure of the first induction cooker integrated stove without an induction cooker bottom housing and an induction cooker hot plate module according to an embodiment of the present disclosure.

FIG. 6 is an exploded view illustrating a filtering device according to an embodiment of the present disclosure.

Numerals of the drawings are described below:
110. induction cooker bottom housing; 120. machine housing; 121. slide groove; 130. panel; 131. air inlet; 140. air guide groove; 141. first air channel; 142. second air channel; 143. inclined surface; 144. water outlet; 150. fan; 160. water receiving tray; 200. induction cooker hot plate module; 210. induction cooker hot plate; 300. induction cooker electric control module; 400. filtering device; 410. air inlet cover; 420. water receiving box; 421. opening; 430. strainer; 500. induction cooker electric control device; 600. cooking bench; 610. mounting groove.

### DETAILED DESCRIPTION OF THE EMBODIMENTS

The embodiments of the present disclosure will be described below in details with the examples thereof shown in the accompanying drawings, and the same or similar reference numerals represent same or similar elements or elements having same or similar function throughout the specification. The embodiments described below by referring to the accompanying drawings are merely illustrative to explain the present disclosure rather than limit the present disclosure.

In the description of the present disclosure, it should be understood that orientations or positional relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise” and “anti-clock wise” are based on orientations or positional relationships shown in the drawings and are used only for convenience and simplification of descriptions of the present disclosure, rather than indicate or imply that the indicated apparatus or element must have a specific orientation and be configured or operated in a specific orientation. Thus, the terms shall not be understood as limiting of the present disclosure. In addition, the terms “first” and “second” are used only for descriptions and shall not be understood as indicating or implying relative importance or implying the number of the indicated technical features. Thus, the features limited by “first” and “second” may explicitly or implicitly include one or more of the features. In the descriptions of the present disclosure, “plurality” refers to two or more unless otherwise stated clearly.

In the descriptions of the present disclosure, the terms such as “install”, “couple”, and “connect” should be understood in a broad sense unless otherwise clearly stated and defined. For example, it can be fixed connection, or detachable connection or integral connection; or mechanical connection, or electrical connection or mutual communication; or direct connection or indirect connection through intermediate medium or internal communication between two elements or interaction relationship between elements. Those skilled in the arts can understand the specific meanings of the above terms in the present disclosure based on actual situations.

In the present disclosure, that a first feature is “on” or “under” a second feature may include direct contact between the first feature and the second feature, or indirect contact between the first feature and the second feature by another feature therebetween, unless clearly stated and defined otherwise. Further, that the first feature is “on”, “over” and “above” the second feature may refer to that the first feature is just or obliquely above the second feature, or may only refer to that the first feature is higher than the second feature in horizontal height. That the first feature is “under”, “beneath” and “below” the second feature may refer to that the first feature is just or obliquely below the second feature, or may only refer to that the first feature is smaller than the second feature in horizontal height.

The following disclosure provides many different embodiments or examples to implement different structures of the present disclosure. For simplification of disclosure of the present disclosure, the parts and disposals of specific examples are described below. Of course, the descriptions are only illustrative and are not intended to limit the present disclosure. Furthermore, in the present disclosure, reference numerals and/or reference letters can be repeated in different examples for the purpose of simplification and clarity and do not indicate any relationship between various embodiments and/or disposals under discussion. Furthermore, the present disclosure provides the examples of various specific processes and materials, but those skilled in the arts can be aware of application of other processes and/or use of other materials.

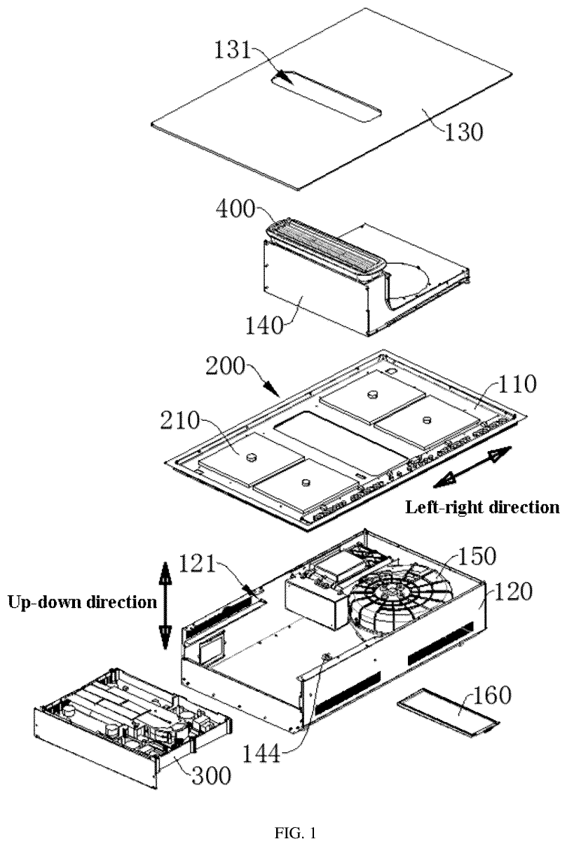

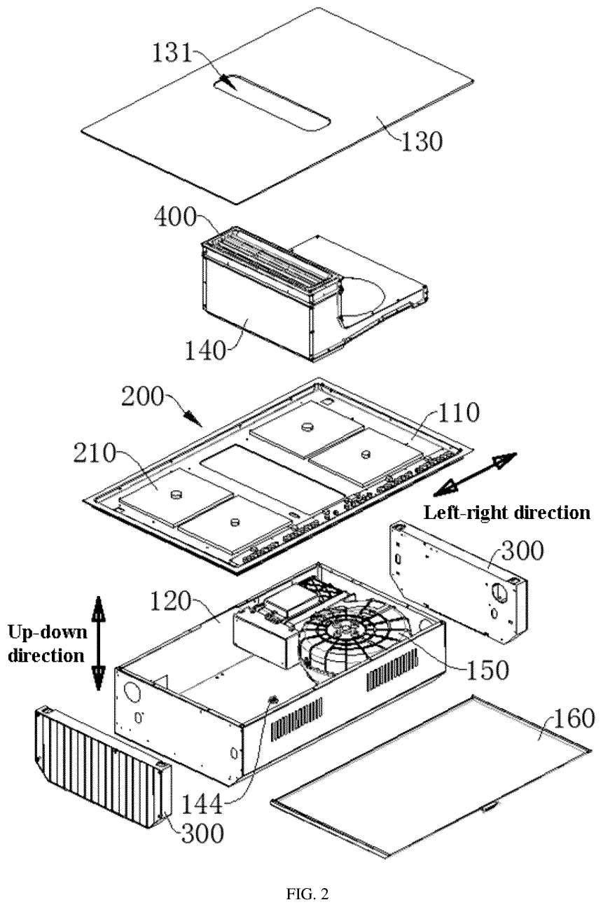

It should be noted that the “left-right direction” and “up-down direction” mentioned below can be referred to the arrows marked in FIGS. 1 and 2.

With reference to FIGS. 1 and 2, the present disclosure provides an induction cooker integrated stove, which includes an induction cooker bottom housing 110, a machine housing 120 below the induction cooker bottom housing 110, and an induction cooker hot plate module 200, where the induction cooker hot plate module 200 is mounted inside the induction cooker bottom housing 110 and includes at least one induction cooker hot plate 210; the induction cooker integrated stove further includes:

an induction cooker electric control module 300, where the induction cooker electric control module 300 is separated from the induction cooker hot plate module 200 and separately mounted on the machine housing 120; the induction cooker electric control module 300 is connected with the induction cooker hot plate 210 to control the induction cooker hot plate 210.

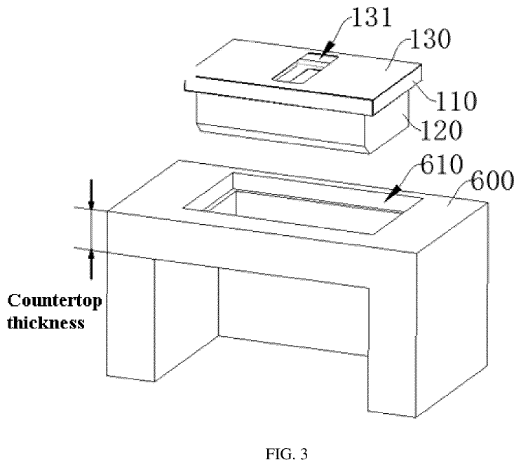

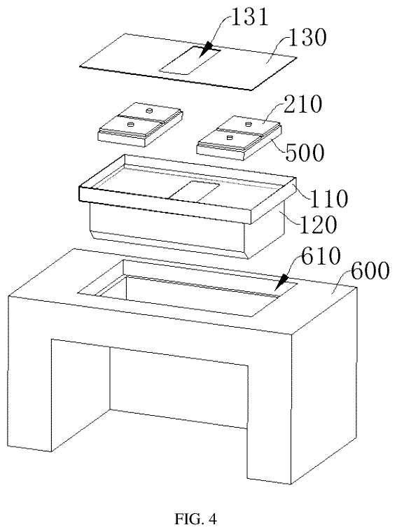

With reference to FIGS. 3 and 4, in the prior arts, the induction cooker hot plate 210 and the induction cooker electric control device 500 both have a thickness, whereas the existing hot plate assembly integrates the induction cooker hot plate 210 to be above the induction cooker electric control device 500 and the whole hot plate assembly is mounted inside the induction cooker bottom housing 110. Therefore, in the existing induction cooker integrated stoves, the thickness of the induction cooker bottom housing 110 is usually greater than a sum of the thicknesses of the induction cooker hot plate and the induction cooker electric control device. However, there emerge cooking benches with a decreasingly small countertop thickness to cater to the consumers on the market. When the existing induction cooker integrated stove is mounted on the cooking bench, the panel on the induction cooker bottom housing usually goes beyond the surface of the cooking bench, which, on the one hand, does not comply with the mounting requirements of the induction cooker integrated stove, and on the other hand, brings poor aesthetics. Therefore, the above existing induction cooker integrated stove is not applicable to this kind of cooking benches. With market expansion, the general applicability of the above existing induction cooker integrated stove is gradually lowered.

For the above reasons, in this embodiment, modularization designing is performed on the existing induction cooker hot plate 210 and induction cooker electric control device 500 respectively to obtain the induction cooker hot plate module 200 and the induction cooker electric control module 300 which are independent of each other and separated from each other. Furthermore, only the induction cooker hot plate module 200 is mounted inside the induction cooker bottom housing 110 and the induction cooker electric control module 300 is independently disposed on the machine housing 120 outside the induction cooker bottom housing 110. In this case, the thickness of the induction cooker bottom housing 110 is further reduced, helping the application of the induction cooker integrated stove to the above cooking bench.

In some embodiments, the induction cooker electric control module 300 is connected with the induction cooker hot plate 210 by a detachable wire and detachably connected with the machine housing 120.

In this embodiment, the detachable connection includes but not limited to plug connection, snap connection, screw connection and magnetic attraction connection and the like. A user can, after pulling out the wire, take out the induction cooker electric control module 300 separately, further helping the user to repair or change the induction cooker electric control module 300.

In some embodiments, with reference to FIG. 1, the induction cooker electric control module 300 is mounted inside the machine housing 120.

Specifically, for example, a slide groove 121 is disposed in the machine housing 120 and the induction cooker electric control module 300 can be slidably disposed in the slide groove 121, so as to realize plug connection of the induction cooker electric control module 300 and the machine housing 120. In practical applications, the induction cooker electric control module 300 is driven to move along the slide groove 121 so that the induction cooker electric control module 300 can be easily pulled out from the machine housing 120 or the induction cooker electric control module 300 can be inserted into the machine housing 120, featuring simple structure and convenient operation.

In some embodiments, with reference to FIG. 2, the induction cooker electric control module 300 is mounted on an outer side of the machine housing 120.

Specifically, for example, the induction cooker electric control module 300 is snap-fitted to the left and right sides of the machine housing 120 so that the induction cooker electric control module 300 is disposed outside the machine housing 120, which, on the one hand, helps heat dissipation of the induction cooker electric control module 300 and on the other hand, better helps the user to repair the induction cooker electric control module 300.

In some embodiments, with reference to FIGS. 1, 2, and 5, disposed on the induction cooker bottom housing 110 is a panel 130 provided with an air inlet 131 penetrating through the panel 130 in an up-down direction.

The induction cooker integrated stove further includes an air guide groove 140 and a fan 150. One end of the air guide groove 140 is in communication with the air inlet 131 and the other end is connected with the fan 150. The fan 150 is used to extract oil fume through the air guide groove 140.

In this embodiment, in practical applications, the fan 150 enables the air guide groove 140 to generate a negative pressure so that the oil fume is extracted through the air inlet 131 into the air guide groove 140. In this case, the induction cooker integrated stove is integrated with an oil fume extracting function, achieving oil fume reduction effect.

In some embodiments, with reference to FIGS. 1, 2, 5 and 6, the air guide groove 140 includes a first air channel 141 and a second air channel 142, where the first air channel 141 is in communication with the second air channel 142 to form an air channel structure with an L-shaped section. The first air channel 141 extends in the up-down direction and communicates with the air inlet 131, and the second air channel 142 extends in a left-right direction and connects with the fan 150. The designing of the L-shaped air channel structure can increase the oil fume extracting effect and help reduce escaping oil fume, thus avoiding the spread of the oil fume.

In some embodiments, with reference to FIGS. 1, 2, 5 and 6, an end of the first air channel 141 close to the air inlet 131 is connected with a filtering device 400.

In this embodiment, the L-shaped air channel structure brings inconvenience to the user cleaning the second air channel 142. For the purpose of avoiding accumulation of grease in the second air channel 142, the filtering device 400 is disposed at the air inlet 131 to filter oil fume. In practical applications, oil fume can normally run through the filtering device 400 but grease and moisture in the oil fume are trapped in the filtering device 400, so that the second air channel 142 and the fan 150 can be kept clean while the oil fume is not discharged directly.

Furthermore, since the filtering device 400 is disposed at the air inlet 131, the user can also collect some kitchen wastes (including solid wastes and liquid wastes) on the surface of the panel 130 into the filtering device 400, helping the user to quickly clean the panel 130.

Furthermore, the filtering device 400 is detachably connected at the air inlet 131. The detachable connection includes but not limited to plug connection, snap connection, screw connection, magnetic attraction connection and the like. In this way, the user can easily remove the filtering device 400 for cleaning or change.

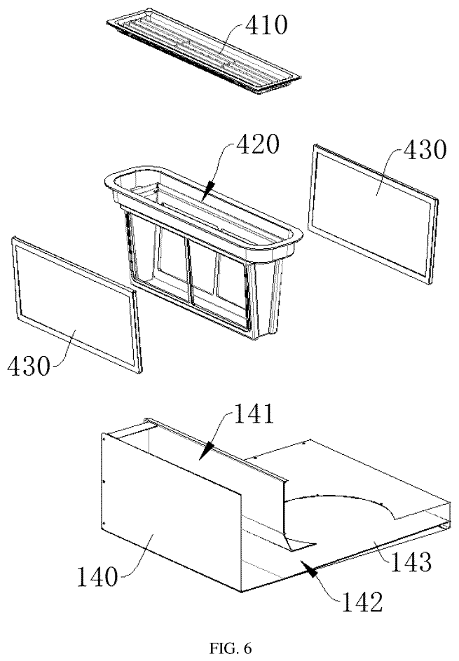

In some embodiments, with reference to FIG. 6, the filtering device 400 includes an air inlet cover 410, a water receiving box 420 and a strainer 430. The water receiving box 420 is inserted into the first air channel 141 with an opening 421 disposed on top. The air inlet cover 410 is mounted on the water receiving box 420 and covered on the opening 421. The strainer 430 is mounted on a peripheral side of the water receiving box 420.

In this embodiment, for the purpose of preventing the kitchen wastes of large volume entering the filtering device 400 and thus affecting the oil fume filtering effect of the filtering device 400, the air inlet cover 410 is disposed on the opening 421 to block the kitchen wastes of large volume, while other kitchen wastes and oil fumes enter the water receiving box 420 through the air inlet cover 410. Finally, the strainer 430 further blocks the kitchen wastes and grease to ensure only the degreased air can run through the air channel structure.

Furthermore, the strainer 430 is an iron wire strainer which is detachably connected to the water receiving box 420. The detachable connection includes but not limited to plug connection, snap connection, screw connection, magnetic attraction connection and the like. In this way, the user can easily remove the strainer 430 for cleaning or change.

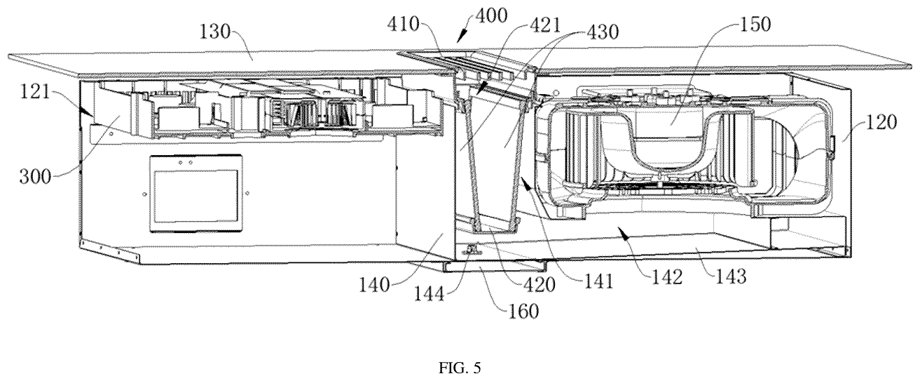

In some embodiments, with reference to FIGS. 5 and 6, a bottom surface of the second air channel 142 is an inclined surface 143 tilted from top down toward the bottom of the first air channel 141 in the left-right direction.

In this embodiment, in practical applications, when excess kitchen wastes and liquids are accumulated in the filtering device 400, it is unavoidable that liquid leakage may occur under the action of pressure. Specifically, the liquids accidentally penetrate through the strainer 430 under the action of pressure and drop into the first air channel 141 and the second air channel 142. At this time, since the bottom of the second air channel 142 is the inclined surface 143 tilted toward the bottom of the first air channel 141, the liquids on the second air channel 142 can be guided by the inclined surface 143 to the bottom of the first air channel 141, thereby avoiding liquid accumulation in the second air channel 142, and keeping the second air channel 142 clean, and hence lowering the difficulty of the user in cleaning the air channel structure.

In some embodiments, with reference to FIGS. 1, 2, and 5, a water outlet 144 disposed at the bottom of the first air channel 141, and a water receiving tray 160 is mounted below the water outlet 144 and communicated with the water outlet 144.

The liquids accumulated at the bottom of the first air channel 141 flow into the water receiving tray 160 through the water outlet 144. In this case, the first air channel 141 can be cleaned conveniently, and because the first air channel 141 extends in the up-down direction, the user can, after removing the filtering device 400, easily reach his hand into the first air channel 141 and clean the first air channel 141, leading to convenient operation and making the first air channel 141 easy to clean.

In the descriptions of the present specification, the descriptions made by referring the terms “one embodiment”, “some embodiments”, “illustrative embodiments”, “examples”, “specific examples”, or “some examples” and the like are meant to indicate the specific features, structures, materials or features described in combination with the embodiments or examples are included in at least one embodiment or example of the present disclosure. In the present specification, the exemplary expressions of the above terms do not necessarily refer to same embodiments or examples. Furthermore, the specific features, structures, materials or features described can be combined in a proper way in any one or more embodiments or examples.

The above descriptions are only about some embodiments of the present disclosure. Many variations and improvements made by those skilled in the arts without departing from the creative idea of the present disclosure shall fall within the scope of protection of the present disclosure.

1. An induction cooker integrated stove, comprising an induction cooker bottom housing (110), a machine housing (120) below the induction cooker bottom housing (110), and an induction cooker hot plate module (200); wherein the induction cooker hot plate module (200) is mounted inside the induction cooker bottom housing (110) and comprises at least one induction cooker hot plate (210);
further comprising:
an induction cooker electric control module (300), wherein the induction cooker electric control module (300) is separated from the induction cooker hot plate module (200) and separately mounted on the machine housing (120); the induction cooker electric control module (300) is connected with the induction cooker hot plate (210) to control the induction cooker hot plate (210).

2. The induction cooker integrated stove according to claim 1, wherein the induction cooker electric control module (300) is connected with the induction cooker hot plate (210) by a detachable wire and detachably connected with the machine housing (120).

3. The induction cooker integrated stove according to claim 1, wherein the induction cooker electric control module (300) is mounted inside the machine housing (120).

4. The induction cooker integrated stove according to claim 1, wherein the induction cooker electric control module (300) is mounted on an outer side of the machine housing (120).

5. The induction cooker integrated stove according to claim 1, wherein disposed on the induction cooker bottom housing (110) is a panel (130) provided with an air inlet (131) penetrating through the panel (130) in an up-down direction;
the induction cooker integrated stove further comprises an air guide groove (140) and a fan (150); one end of the air guide groove (140) is in communication with the air inlet (131) and the other end is connected with the fan (150); the fan (150) is used to extract oil fume through the air guide groove (140).

6. The induction cooker integrated stove according to claim 5, wherein the air guide groove (140) comprises a first air channel (141) and a second air channel (142); the first air channel (141) is in communication with the second air channel (142) to form an air channel structure with an L-shaped section; the first air channel (141) extends in the up-down direction and communicates with the air inlet (131), and the second air channel (142) extends in a left-right direction and connects with the fan (150).

7. The induction cooker integrated stove according to claim 6, wherein an end of the first air channel (141) close to the air inlet (131) is connected with a filtering device (400).

8. The induction cooker integrated stove according to claim 7, wherein the filtering device (400) comprises an air inlet cover (410), a water receiving box (420) and a strainer (430); the water receiving box (420) is inserted into the first air channel (141) with an opening (421) disposed on top; the air inlet cover (410) is mounted on the water receiving box (420) and covered on the opening (421); the strainer (430) is mounted on a peripheral side of the water receiving box (420).

9. The induction cooker integrated stove according to claim 6, wherein a bottom surface of the second air channel (142) is an inclined surface (143) tilted from top down toward the bottom of the first air channel (141) in the left-right direction.

10. The induction cooker integrated stove according to claim 9, wherein a water outlet (144) disposed at the bottom of the first air channel (141), and a water receiving tray (160) is mounted below the water outlet (144) and communicated with the water outlet (144).
